(19) United States
(12) Patent Application Publication
(10) Pub. No.: US 2013/0242159 A1
(43) Pub. Date: Sep. 19, 2013

(54) IMAGING DEVICE AND DISPLAY PROCESS METHOD

(71) Applicant: Kei ITOH, Yokohama-shi (JP)

(72) Inventor: Kei ITOH, Yokohama-shi (JP)

(21) Appl. No.: 13/840,139

(22) Filed: Mar. 15, 2013

(30) Foreign Application Priority Data
Mar. 19, 2012 (JP) 2012-061521

(51) Int. Cl. H04N 5/232

(52) U.S. Cl. CPC H04N 5/23293
USPC 348/333.03

(57) ABSTRACT

An imaging device includes a shooting lens configured to image an image of a subject through passage of light from the subject, an imaging unit configured to receive light which has passed through the shooting lens, and convert the received light into an electric signal, so as to generate image data of the subject, and a display on which the image data is displayed, wherein when a predetermined condition is satisfied, the shooting lens is moved to a predetermined position on a close side, focal point information is calculated from the image data, and the image data is displayed on the display by a display mode which visibly displays the focal point information.

### PRIORITY CLAIM

The present application is based on and claims priority from Japanese Patent Application No. 2012-061521, filed on Mar. 19, 2012, the disclosure of which is hereby incorporated by reference in its entirety.

### BACKGROUND

1. Field of the Invention

The present disclosure relates to an imaging device which manually or automatically detects a focal point, and a display process method which is performed by the imaging device.

2. Description of the Related Art

An imaging device such as a general digital still camera has an autofocus (hereinafter referred to as AF) function which can automatically focus on a subject.

A hill-climbing AF control method is known as one example of an AF control method of an AF function (refer to, for example, Patent Document 1, JP S39-5265A). In the hill-climbing AF control method, an integral value of brightness differences of adjacent pixels is obtained from picture signals output from an imaging element, and this integral value becomes an AF evaluation value indicating a focused degree.

An AF evaluation value of a hill-climbing AF control method will be herein described. A contoured part of a subject in picture signals is clear when a subject is in a focused state. For this reason, a brightness difference between adjacent pixels in picture signals is increased. Namely, the AF evaluation value is increased in a focused state.

On the other hand, a contoured part of a subject is unclear when a subject is in a non-focused state. For this reason, a brightness difference between adjacent pixels in picture signals is decreased. Namely, the AF evaluation value is decreased in a non-focused state.

In the hill-climbing AF control method, a focused state is determined as described below by using such an AF evaluation value, so as to detect a focused position. More specifically, in the hill-climbing AF control method, an AF evaluation value is calculated by obtaining picture signals in a plurality of lens positions while moving a lens in a predetermined timing.

In the hill-climbing AF control method, a focused position is detected by detecting the maximum value of the AF evaluation values (peak position of AF evaluation values). According to such a hill-climbing AF control method, a subject can be automatically focused by moving a lens to a position where the AF evaluation value becomes the maximum.

By the way, a photographer sometimes wishes to shoot a subject at a short distance from the subject with manual focusing without using autofocusing although an imaging device having an AF function is used. As a technique which supports a user in such a case, a technique which enhances an edge such that a user can easily confirm a focused state is known (refer to, for example, Patent Document 2, W2010-114556A and Patent Document 3, JP2010-0167834A).

The minimum shooting distance is defined in an imaging device as the minimum distance that the imaging device is able to focus on a subject. It is therefore necessary for a user to confirm that a distance (shooting distance) from a leading end of a focus lens of the imaging device or an imaging element to a subject is longer than the minimum shooting distance before shooting.

However, in a conventional technique, it is necessary for a user to confirm whether or not an actual shooting distance is longer than a predetermined distance (for example, minimum shooting distance) by visual measurement or actual measurement. For example, a method of confirming such a distance by visual measurement includes a method of confirming such a distance by shooting a subject while moving an imaging device little by little, and expanding the image data.

Even when the technique described in Patent Document 2 or 3 is used, it cannot be confirmed whether or not the distance from a subject to the present shooting position is longer than the minimum shooting distance although it may be confirmed whether or not a subject is focused in the present shooting position.

As described above, it cannot be confirmed with the conventional technique whether or not the actual distance between the imaging device and the subject is longer than the minimum photographing distance.

### SUMMARY

The present disclosure has been made in view of the above circumstances, and an object of the present disclosure is to provide an imaging device and a display process method by which a user can easily recognize a positional relationship between an imaging device and a subject.

In order to achieve the above object, one embodiment of the present disclosure provides an imaging device including a shooting lens configured to image an image of a subject through passage of light from the subject, an imaging unit configured to receive light which has passed through the shooting lens, and convert the received light into an electric signal, so as to generate image data of the subject, and a display on which the image data is displayed, wherein when a predetermined condition is satisfied, the shooting lens is moved to a predetermined position on a close side, focal point information is calculated from the image data, and the image data is displayed on the display by a display mode which visibly displays the focal point information.

### BRIEF DESCRIPTION OF THE DRAWINGS

The accompanying drawings are included to provide further understanding of the present disclosure, and are incorporated in and constitute a part of this specification. The drawings illustrate embodiments of the present disclosure and, together with the specification, serve to explain the principle of the present disclosure.

FIG. 1 is a front view illustrating an embodiment of an imaging device according to the present disclosure.

FIG. 2 is a top view of the imaging device.

FIG. 3 is a back view of the imaging device.

FIG. 4 is a block diagram illustrating an example of electric controllers in the imaging device.

FIG. 5 is a flow chart describing a process by an edge detection processor of the imaging device.

FIG. 6 is a schematic view illustrating a differential filter as one example of an edge extraction filter for use in the imaging device.

FIG. 7 is a schematic view illustrating one example of display data in a finder mode of the imaging device.

FIG. 8 is a timing chart illustrating timing of focusing and exposure in the imaging device.

FIG. 9 is a schematic view illustrating one example of an AF frame in the imaging device.

FIG. 10 is a schematic view illustrating a display example on an edge extraction mode screen and a normal mode screen in the imaging device.

FIG. 11 is a flow chart describing a display process of the imaging device.

FIG. 12 is a flow chart describing another display process of the imaging device.

FIG. 13 is a flow chart describing an AF process of the imaging device.

FIG. 14A, 14B, 14C are schematic views each illustrating one example of an evaluation value pattern in an area determination process.

FIG. 15 is a flow chart describing an arca detection process.

FIG. 16 is a flow chart describing another display process of the imaging device.

FIG. 17 is a flow chart describing another area determination process in the display process method.

FIG. 18 is a schematic view illustrating a display example in an edge extraction mode of the imaging device.

### DESCRIPTION OF THE PREFERRED EMBODIMENTS

Hereinafter, an embodiment of an imaging device and a display process method will be described with reference to the drawings. The imaging device includes a display process operation of image data by a display process method as described hereinafter.

A method for achieving the above operation can be achieved as a display process method to a display different from the imaging device.

Embodiment of Imaging Device

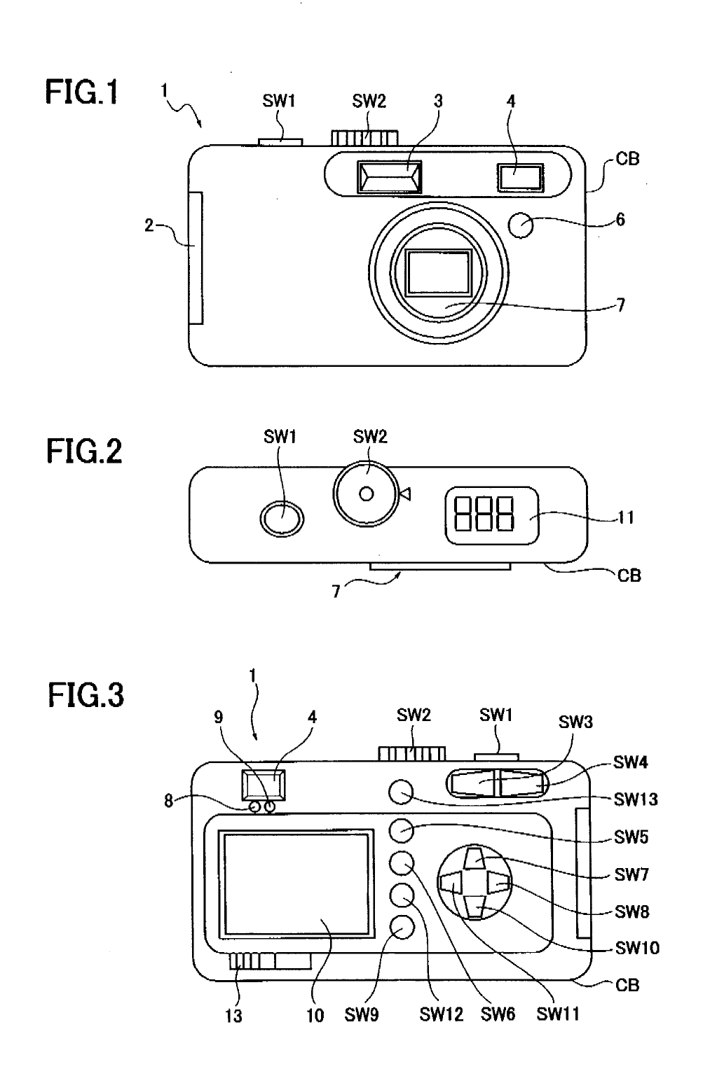

FIG. 1 is a front view illustrating an embodiment of an imaging device which executes a display process method according to the present disclosure. Referring to FIG. 1, a strobe light emitter 3, objective surface of finder 4, remote control light receiver 6, and lens barrel 7 constituting an imaging optical system including an imaging lens are provided on a front face of a camera body CB of an imaging device 1 as a housing of the imaging device 1. A lid 2 for a memory card space and battery space is provided in one side surface of the camera body CB.

FIG. 2 is a top view of the imaging device. Referring to FIG. 2, a release switch SW1, mode dial SW2 and sub liquid crystal display 11 (sub-LCD) are provided on the top surface of the camera body CB. In addition, the liquid crystal display will be hereinbelow referred to as an LCD.

FIG. 3 is a back view of the imaging device 1. Referring to FIG. 3, an eyepiece of the finder 4, AF light-emitting diode 8 (hereinafter, referred to as an LED), strobe LED 9, LCD monitor 10 as a display for a subject image, enlarged image, and various settings, power source switch 13, wide-angle direction zoom switch SW3, telephoto direction zoom switch SW4, self-timer setting and releasing switch SW5, menu switch SW6, upward movement and strobe setting switch SW7, right movement switch SW8, display switch SW9, downward movement and macro switch SW10, left movement and image confirmation switch SW11, OK switch SW12, and quick access switch SW13 are provided on the back surface of the camera body CB.

### Operation Block of Imaging Device

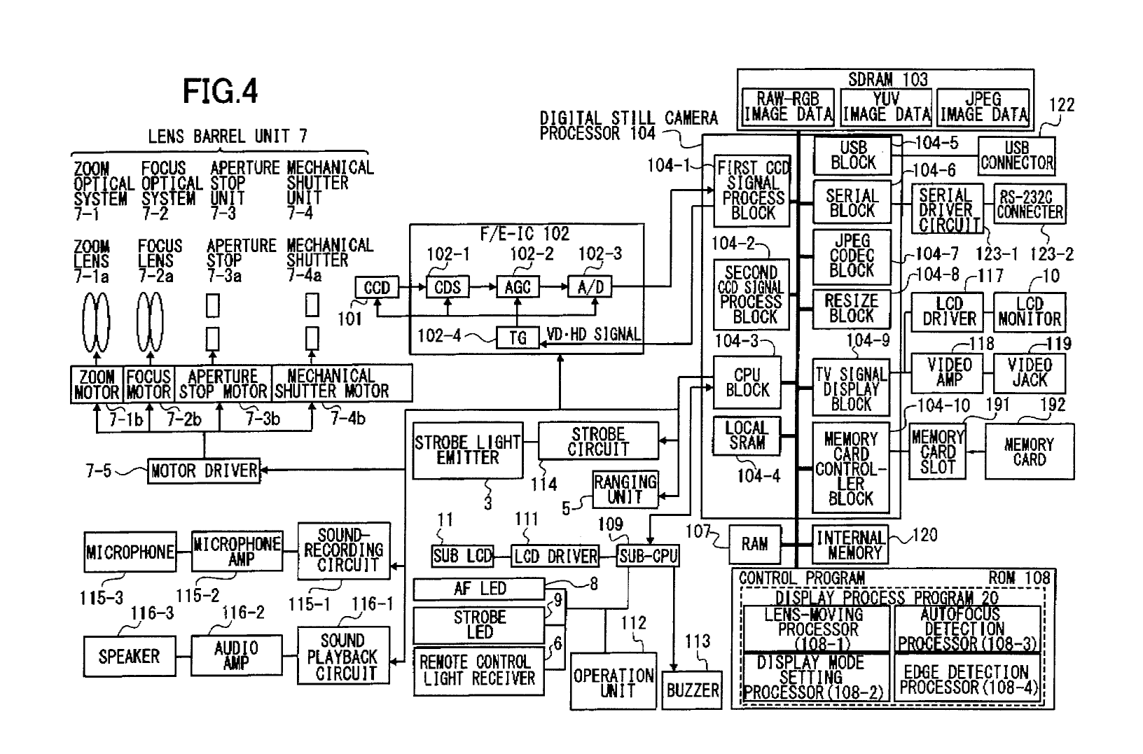

Next, an example of a functional block of the imaging device 1 will be described. FIG. 4 is a block diagram illustrating a functional example of the imaging device 1.

Various operations (processes) of the imaging device 1 are controlled by a digital still camera processor 104 (hereinafter, referred to as a processor 104) including a digital signal process IC (integrated circuit), and an imaging program operating in the processor 104. The processor 104 as an image processor includes a first CCD (charge-coupled device) signal process block 104-1, second CCD signal process block 104-2, CPU (central processing unit) block 104-3, local SRAM (SRAM: static random access memory) 104-4, USB (universal serial bus) block 104-5, serial block 104-6, JPEG CODEC block 104-7, RESIZE block 104-8, TV signal display block 104-9, and memory card controller block 104-10. These blocks are connected by bus lines.

A SDRAM (synchronous random access memory) 103 which stores RAW-RGB image data, YUV image data and JPEG image data, RAM 107, internal memory 120 and ROM 108 which stores a control program as an imaging program are provided outside the processor 104. These are connected to the processor 104 through the bus lines.

The processor 104 executes various not-shown control programs stored in the ROM 108, and achieves functions by the various control programs. The SDRAM 103 corresponds to a frame memory.

The various control programs stored in the ROM 108 are programs by which the processor 104 executes the display process method in the imaging device, and includes a display process program 20.

Namely, in the imaging device 1, the function regarding the display process method which is performed by the imaging device 1 is achieved by executing the display process program 20 stored in the ROM 108 with the processor 104 and by using the SDRAM 103, RAM 107 and internal memory 120.

The display process program 20 includes a lens-moving processor 108-1, display mode setting processor 108-2, autofocus (AF) detection processor 108-3 (focused state detector) and edge detection processor 108-4.

The processor 104 can be a computer in which the CPU block 104-3 and the like are mainly connected by a bus line. The CPU block 104-3 executes the display process program 20 stored in the ROM 108, so that the following display process is performed to image data.

The display process program 20 is stored in the ROM 108 in advance. The display process program 20 can be stored in a memory card 192, and can be read in the ROM 108 through a memory card slot 191, or the display process program 20 can be downloaded in the ROM 108 through a not-shown network.

The lens barrel unit 7 as an imaging lens includes a zooming optical system 7-1 having a zoom lens 7-1a, focus optical system 7-2 having a focus lens 7-2a, aperture stop unit 7-3 having an aperture stop 7-3a, and mechanical shutter unit 7-4 having a mechanical shutter 7-4a. The imaging optical system is constituted by these.

The zooming optical system 7-1, focus optical system 7-2, aperture stop unit 7-3, and mechanical shutter unit 7-4 are driven by a zoom motor 7-1a, focus motor 7-2b as a focus lens-moving unit, aperture stop motor 7-3a, and shutter motor 7-4b, respectively. Each of the zoom motor 7-1b, focus motor 7-2b, aperture stop motor 7-3b, and mechanical shutter motor 7-4b are controlled by a motor driver 7-5 which is controlled by the CPU block 104-3 of the processor 104.

The zoom lens 7-1a and focus lens 7-2a of the lens barrel unit 7 constitute an imaging lens which images a subject image on a light-receiving surface of a CCD (charge-coupled device) 101 as an imaging element. The CCD 101 electrically converts a subject image imaged on the light-receiving surface into electric image signals, and outputs the image signals to an FIE-IC (front-end IC) 102.

In addition, in the present embodiment, the imaging element is not limited to a CCD, or can be a CMOS (Complementary Metal Oxide Semiconductor), for example.

The F/E-IC 102 includes a CDS (correlated double sampling) 102-1, AGC (automatic gain controller) 102-2, and A/D (analogue-digital) convertor 102-3. In the F/E-IC 102, the image signals converted from a subject image are converted into digital signals by a predetermined process. The converted digital image signals are input to the first CCD signal process block 104-1. These signal process operations are controlled through a TG (timing generator) 102-4 by VD signals (vertical driving signal) and HD signals (horizontal driving signal) output from the first CCD signal process block 104-1 of the processor 104.

In this case, the CCD 101, CDS 102-1, AGC 102-2, A/D convertor 102-3 and processor 104 correspond to an imaging unit of the present embodiment.

The CPU block 104-3 of the processor 104 controls a sound recording operation by a sound-recording circuit 115-1. The sound recording circuit 115-1 records a sound signal converted by a microphone 115-3 and amplified by a microphone amplifier 115-2 according to the command of the CPU block 104-3. The CPU block 104-3 controls the operation of an audio playback circuit 116-1. The audio playback circuit 116-1 amplifies the sound signal recorded in an appropriate memory by an audio amplifier 116-2 in accordance with the command of the CPU block 104-3, and inputs the amplified voice signal into a speaker 116-3, so as to playback the sound from the speaker 116-3. The CPU block 104-3 controls the operation of a strobe circuit 114 such that illumination light is emitted from a strobe light emitter 3. The CPU block 104-3 controls the operation of a ranging unit 5 which measures a subject distance.

In the imaging device of the present embodiment, it is not always necessary to measure a subject distance by the ranging unit 5, and the ranging unit 5 can be omitted, for example.

When a ranging unit is provided, the measurement information of the subject distance by the ranging unit can be used for the control of the strobe light emission in the strobe circuit 114. The measurement information of the subject distance by the ranging unit can be supplementarily used for the focus control based on the imaged image data.

The CPU block 104-3 is connected to a sub CPU 109 disposed outside the processor 104. The sub CPU 109 controls the display of a sub LCD 11 through an LCD driver 117. The sub CPU 109 is connected to an AF LED 8, strobe LED 9, remote control light receiver 6, operation section 112 having switches SW1-SW13 and buzzer 113.

The USB block 104-5 is connected to a USB connector 122, and the serial block 104-6 is connected to an RS-232C connector 123-2 through a serial driver circuit 123-1. The TV signal display block 104-9 is connected to an LCD monitor 10 through the LCD driver 117, and the TV signal display block 104-9 is also connected to a video jack 119 through a video amp 118.

In addition, the TV signal display block 104-9, LCD driver 117, LCD monitor 10, video amp 118, video jack 119, and not-shown external monitor correspond to a display of the present embodiment.

The memory card controller block 104-10 is connected to the contact point of a memory card slot 191. The memory card is provided in the memory card slot 191, and the memory card has electrical contact with the contact point of the memory card.

The first CCD signal process block 104-1 performs a signal process such as white balance adjustment and γ adjustment on the digital image data input from the CCD 101 through the FIE-IC 102, and outputs VD and HI) signals.

The CPU block 104.3 controls the strobe circuit 114 such that the illumination light is emitted from the strobe light emitter 3.

The USB block 104-5 is connected to the USB connector 122. The serial block 104-6 is connected to the RS-232 connector 123-2 through the serial driver circuit 123-1.

The TV signal display block 104-9 is connected to the LCD monitor 10 through the LCD driver 117. The TV signal display block 104-9 is connected to the video jack 119 through the video amp (AMP) 118.

The memory card controller block 104-10 is connected to the contact point of the memory card slot 191. After the memory card 192 is provided in the memory card slot 191, the memory card controller block has electrically contact with the contact point of the memory card 192, and records an image file in the memory card 192.

Operation of Imaging Device

Next, the operation of the imaging device 1 will be described. In the imaging device 1 illustrated in FIGS. 1-4, the imaging device is activated in a recording mode by setting the mode dial SW2 to the recording mode. The CPU block 104-3 detects that the mode dial SW2 in the operation key unit (SW1-SW13) in FIG. 4 is set to the recording mode through the sub CPU 109, so that the lens barrel 7 is moved to a photographable position by controlling the motor driver 7-5. The CCD 101, F/E-IC 102, LCD monitor 10 and the like are turned on to start the operation thereof. Upon being turned on, the operation of the finder mode is started.

In the finder mode, the light incident in the CCD 101 as an imaging element is converted into electric signals to be input to the CDS 102-1 as ROB analogue signals, and the analogue signals are sent to the A/D convertor 102-3 through the AGC 102-2.

Each of RGB signals converted into digital signals by the A/D convertor 102-3 is converted into YUV image data by a YUV convertor achieved by the second CCD signal process block 104-2 in the processor 104, and is recorded in the SDRAM 103 as a frame memory.

In addition, the second CCD signal process block 104-2 executes a filtering process on RGB image data so as to convert the RGB image data into YUV image data. This YUV image data is read by the CPU block 104-3, and is sent to a display such as a not-shown TV through the TV signal display block 104-9, video amp 118 and video jack 119 or the LCD monitor 10 through the LCD driver 117 to be displayed thereon. This process is performed at 1/30 second intervals to obtain the display image of the finder mode in the display, which is updated every 1/30 second.

Two types of display methods can be selected for the display image of the finder mode. One is a normal mode and the other is an edge extraction mode. The normal mode and edge extraction mode are switched by a filtering process with the following edge detection processor 108-4.

FIG. 5 is a flow chart describing a process by the edge detection processor 108-4 of the imaging device 1. The edge detection processor 108-4 determines a process mode to Y signal before filtering (S1).

In the case of the normal mode, the edge detection processor 108-4 outputs the Y signal of the YUV signals converted from RUB with no change, and completes the normal mode.

In the case of the edge extraction mode, the edge detection processor 108-4 performs an edge extraction filtering process (S2) on the Y signal before filtering. Then, the edge detection processor 108-4 performs a gain multiplication process (S3) after the process in S2, and outputs the Y signal as the Y signal after the filtering process.

The edge extraction filter for use in the filtering process includes various filters such as a differential filter, Sobel filter, or Roberts filter. An arbitrary edge extraction filter can be used in this embodiment.

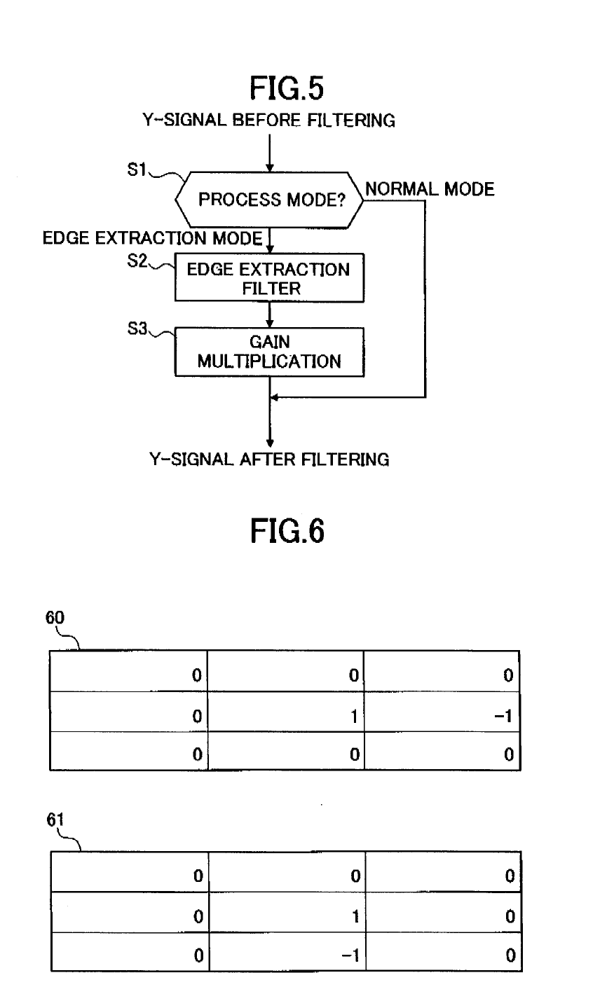

FIG. 6 illustrates a differential filter as one example of an edge extraction filter for use in the imaging device 1. In FIG. 6, reference number 60 is a differential filter in the horizontal direction, and reference number 61 is a differential filter in the vertical direction. By using such an edge extraction filter, edge information is extracted from the image data before processing (image data generated by second CCD signal process block 104-2).

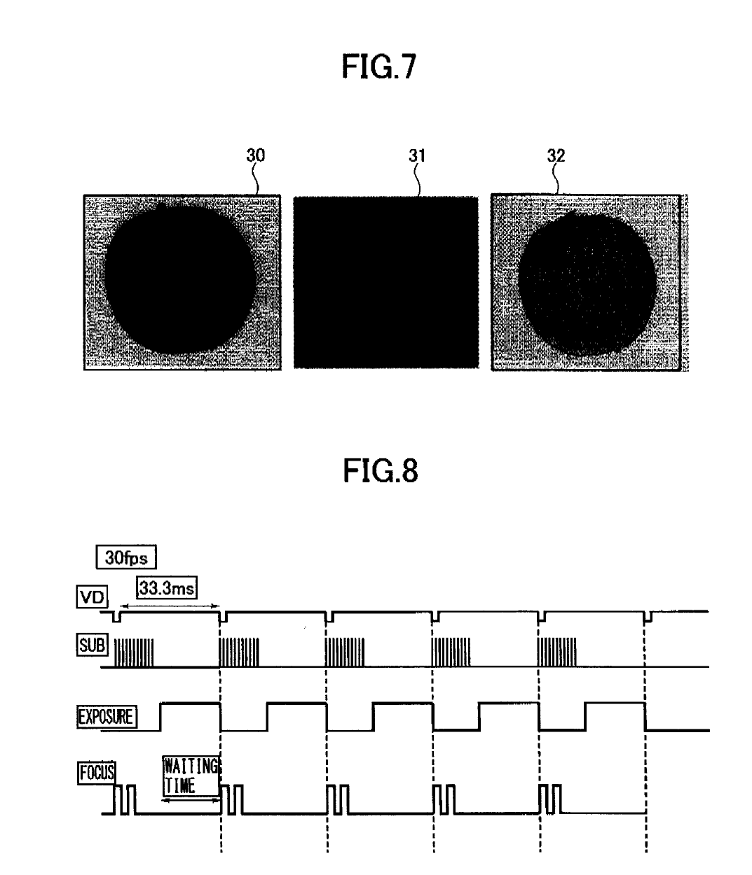

FIG. 7 is a schematic view illustrating one example of the image data in the finder mode of the imaging device 1. In FIG. 7, reference number 30 denotes the image data of the normal mode, reference number 31 denotes the image data in which the edge is extracted from the image data 30 of the normal mode, and reference number 32 denotes the image data of the edge extraction mode. The image data 32 of the edge extraction mode is an image in which the black and white are inverted from the image data 31 in which the edge is extracted, and the extracted edge is emphasized.

Upon the pressing of the release switch SW1 of the operation unit, the AF evaluation value indicating the focused degree at least in a predetermined portion in a screen and the AE evaluation value indicating the exposure condition are calculated by the digital RGB image data loaded in the first CCD signal process block 104-1. The AF evaluation value is read by the CPU block 104-3 as characteristic data, and is used for the AF process as the autofocus detection processor 108-3.

A high-frequency component of a spatial frequency in the image data becomes the maximum because a focused subject has a clear edge portion. In the hill-climbing AF control method, the AF evaluation value calculated by using the image data of the subject is set to a value in which the height of the high-frequency component is reflected as a differential value to displacement, for example.

In the hill-climbing AF control method, the position of the focus lens 7-2a where the image data in which the AF evaluation value becomes the maximum value (peak) is obtained. Namely, according to the hill-climbing control method, the focused position can be specified by detecting the peak position of the AF evaluation value.

When a plurality of maximum points of AF evaluation values are obtained, the size of the AF evaluation value in a plurality of peak positions and the decrease or increase of the AF evaluation values in the peripheral positions are considered. Then, the AF process in which the maximum point assumed as the most reliable maximum point is the focused position is executed.

When executing the AF process, the AF evaluation value is obtained in a predetermined position (timing) while moving the focus lens 7-2a, and the focused state is determined and the focused position is specified by using the obtained AF evaluation value.

Next, the relationship between the timing for moving the focus lens 7-2a in the AF process and the timing for obtaining the AF evaluation value will be described. The driving amount of the focus lens 7-2a corresponds to one VD signal, and the motor driver 7-5 sets a predetermined focus driving amount. The focus driving amount corresponds to the number of driving pulses when the focus motor 7-2a is a pulse motor, for example.

One driving of the focus lens 7-2a is completed by driving the focus lens 7-2a with a predetermined number of driving pulses at a predetermined pulse rate in accordance with the falling of the pulse of the VD signal. The motor driver 7-5 again controls predetermined focus driving in accordance with the falling of the pulse of the next VD signal. The motor driver 7-5 therefore synthesizes the focus driving with the VD signal (frame synchronization).

FIG. 8 is one example of a timing chart illustrating focusing timing and exposure timing in the imaging device 1. FIG. 8 illustrates VD signals when loading image data at a frame rate of 30 fps, focus driving timing of the focus lens 7-2a, timing of a charge discharging pulse (SUB) in an electric shutter, and exposure timing.

Upon the generation of one VD signal as trigger, two pulses for driving the focus lens 7-2a are generated, and the focus lens 7-2a is moved by the driving amount corresponding to the two driving pulses.

In addition, a predetermined number of charge discharging pulses is generated by using the VD signal as a trigger, and a process for discharging charge charged in the CCD 101 is performed according to the number of SUBs.

An exposure process is performed after completing the process for discharging charge in the CCD 101. A subject image is loaded as image data by the exposure process. The CCD 1 signal process block 104-1 obtains the AF evaluation value by using the image data. The number of driving pulses is variable, and is varied according to the focus lens extending amount (focus driving range) and a focal length.

As described above, the AF process is performed by the first CCD signal process block 104-1 with the synchronization to the VD signal in the driving range of the focus lens 7-2a.

The AF evaluation value can be calculated from a specified range (AF process area) in the digital ROB image data.

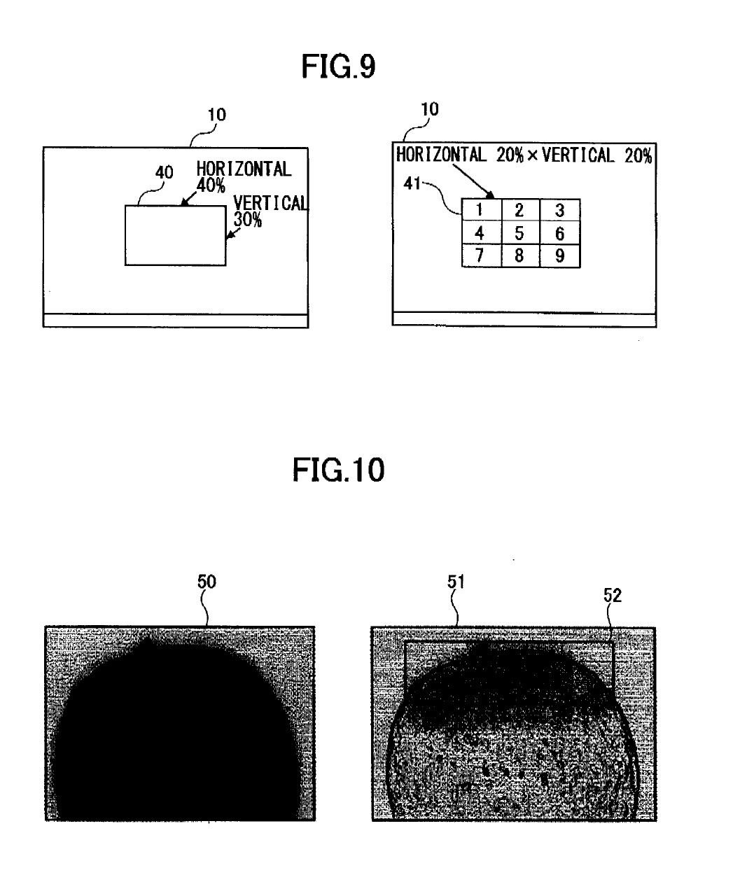

FIG. 9 is a schematic view illustrating one example of an AF frame in the imaging device. In FIG. 9, each frame displayed in the central portion of the LCD monitor 10 is the AF process area in the imaging device, and illustrates a normal AF frame 40 and a multi-AF frame 41.

The normal AF frame 40 is set in a range of 30% in the vertical direction and 40% in the horizontal direction in the center of the screen of the RGB image data, for example.

The multi-AF frame 41 is set as 9 areas each having a range of 20% in the vertical direction and 20% in the horizontal direction. The normal AF frame 40 and the multi-AF frame 41 can be set in the imaging device 1.

### Embodiment 1

Next, Embodiment 1 as one example of the display process method will be described. Embodiment 1 is an example for visibly recognizing the positional relationship between a subject and a focused position in a predetermined position of the focus lens 7-2a through the finder or LCD monitor 10 in the manual focusing (hereinafter, referred to as MF) process mode. More specifically, Embodiment 1 is an example for visibly recognizing whether or not a distance between the subject and the focus lens 7-2a is longer than the minimum shooting distance in the closest position of the focus lens 7-2a.

FIG. 10 is a schematic view illustrating a display example of the edge extraction mode screen and the normal mode screen in the imaging device 1. In FIG. 10, reference number 50 denotes the display example of the normal mode screen and reference number 51 denotes the display example of the edge extraction mode screen.

In addition, in Embodiment 1, the default display in the finder mode is the normal mode screen 50.

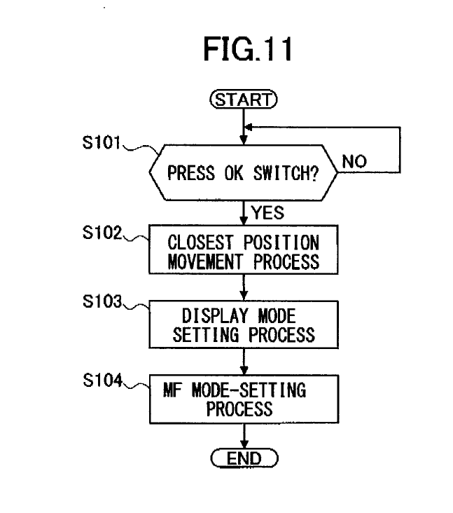

FIG. 11 is a flow chart describing the display process by the imaging device 1.

The lens-moving processor 108-1 confirms whether or not the OK switch is pressed by a user, which is one example of a predetermined condition for moving the focus lens 7-2a (S101).

When the OK switch SW12 is pressed by a user (YES in S101), the lens-moving processor 108-1 moves the focus lens 7-2a to the closest position (S102). The closest position is a position defined by an angle of view of the focus lens 7-2a and the zoom lens 7-1a, and also a lens position in the minimum shooting distance. The minimum shooting distance is a unique distance which is defined by the zoom lens 7-1a and the focus lens 7-2a, and can achieve focusing on a subject.

In addition, when the OK switch SW12 is not pressed (NO in S101), the lens-moving processor 108-1 repeats the process in S101.

After the lens position is moved to the closest position, the display mode setting processor 108-2 changes the display mode in the finder mode to the edge extraction mode.

After changing the display mode to the edge extraction mode, the edge detection processor 108-4 extracts the edge information from the image data, and calculates the edge extraction mode screen 51 (S103).

In the edge extraction mode screen 51, the focus information 52 is displayed in the rectangular frame range. The imaging device 1 displays a subject on the edge extraction mode screen 51 and also the focus information 52, so that a user can confirm the actual focused position and the focused state.

After displaying the focus information 52 on the edge extraction mode screen 51, the imaging device 1 changes the focal point detection mode to MF (S 104) such that the AF process is not performed even when the release switch SW1 is pressed. In this way, a user can move the position of the imaging device 1 to a subject with reference to the focus information 52, and quickly start shooting.

The display of the edge extraction mode screen 51 on the LCD monitor 10 can be released when the OK switch SW12 is pressed again, for example, and the display can be moved to the normal mode screen 50.

Operation and Effect of Embodiment 1

The imaging device 1 includes the shooting lens (lens barrel 7) configured to image an image of a subject through passage of light from the subject, the imaging unit (CCD 101, CDS 102-1, AOC 102-2, A/D convertor 102-3, processor 104) configured to receive light which has passed through the shooting lens, and convert the received light into an electric signal, so as to generate image data of the subject, and the display (LCD driver 117, LCD monitor 10, TV signal display block 104-9, video amp 118 and video jack 119) on which the image data is displayed, wherein when a predetermined condition is satisfied, the shooting lens is moved to a predetermined position on a close side, focal point information is calculated from the image data, and the image data is displayed on the display by a display mode which visibly displays the focal point information.

According to the above imaging device 1, the shooting lens is moved to a predetermined position under a predetermined condition, the edge component of a subject is extracted, and the focus information 52 is visibly displayed on the display as one example of focal point information, so that a user can easily recognize the positional relationship (focused state) between the focal point of the shooting lens and the subject. According to the imaging device 1, in the case of shooting at the periphery of a predetermined position of the shooting lens on the closest side, when the positions of the shooting lens and the imaging device 1 are slightly adjusted, a user can easily focus on a subject, so that a time to start shooting can be reduced.

The predetermined condition is satisfied in the imaging device 1 when the operation unit of the imaging device 1 (for example, various switches of the operation unit 112 such as the OK switch SW12) is operated. According to the above imaging device 1, the above display process method can be performed based on the operation of a user, and convenience for a user can be improved.

In the imaging device 1, the focal point information is edge information, and the display mode is a mode which visibly displays the edge information of the image data. According to the above imaging device 1, the edge component of a subject is extracted, and the focus information 52 is visibly displayed on the edge extraction mode screen 51 as one example of the focal point information, so that a high edge of a subject, namely, a focused state can be confirmed.

In the imaging device 1, the predetermined position of the shooting lens on the close side is the closest position. According to the above imaging device 1, a user can easily view the positional relationship between the subject and the minimum shooting distance of the imaging device 1 in the closest position of the shooting lens 1.

### Embodiment 2

Next, Embodiment 2 as another example of the display process method will be described. In the display process method of Embodiment 2, the focused position is calculated by the focused state detector (autofocus detection processor) in order to determine whether or not a subject is focused in a predetermined area in the AF process mode. In the display process method of Embodiment 2, it is determined whether or not the predetermined condition as the focused position is satisfied. Then, the focus lens 7-2a is moved, and the focal point information is displayed on the LCD monitor 10.

In Embodiment 2, the default display in the finder mode is the normal mode screen 50.

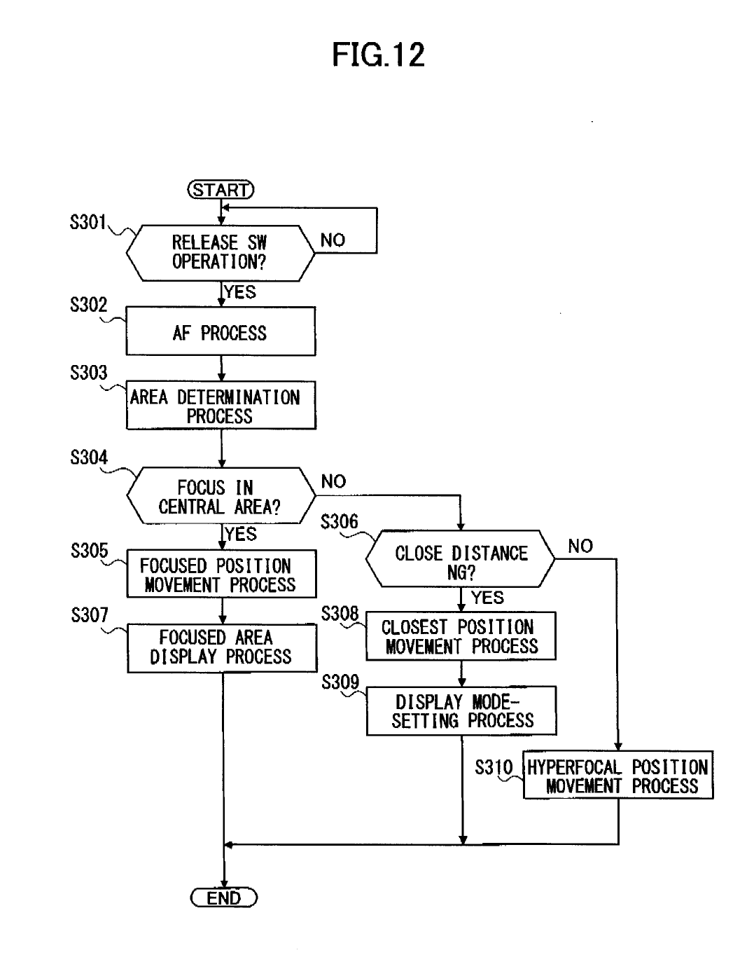

FIG. 12 is a flow chart describing another display process of the imaging device 1.

At first, the lens-moving processor 108-1 determines whether or not the release switch SW1 is pressed (S301) as an operation of the operation unit which is one example of the predetermined condition. The display process method of Embodiment 2 (process after S302) can be executed without determining the pressing of the release switch SW1.

In addition, when the release switch SW1 is not pressed (NO in S301), the lens-moving processor 108-1 repeats the process in S301.

When the release switch SW1 is pressed (YES in S301), the autofocus detection processor 108-3 performs the AF process (S302). In Embodiment 2, the AF area for the AF process is the multi-AF frame 41.

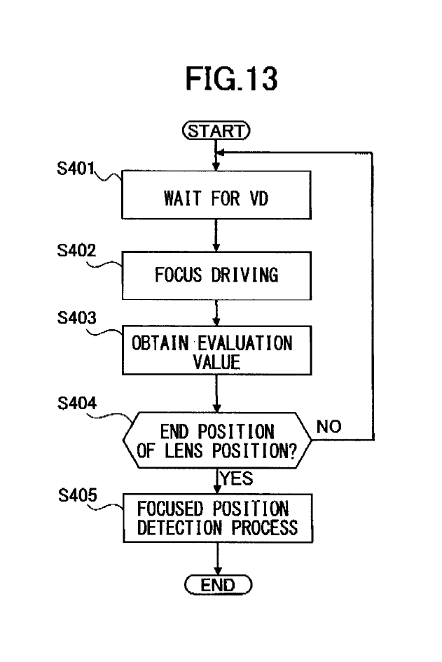

FIG. 13 is a flow chart describing the AF process by the imaging device 1.

At first, the autofocus detection processor 108-3 executes a waiting process until the falling of the VD signal is detected (S401).

The autofocus detection processor 108-3 drives the focus motor 7-2b according to a predetermined number of pulses after detecting the falling of the VD signal, and moves the focus lens 7-2a (S402).

The autofocus detection processor 108-3 obtains the picture signals from the first CCD signal process block 104-1 after moving the focus lens 7-2a, and calculates the AF evaluation values by the image data (digital RGB image data) based on the picture signals (S403).

The autofocus detection processor 108-3 obtains the positional information of the focus lens 7-2; and determines whether or not the position of the focus lens 7-2a has reached the driving end position (S404). When the position of the focus lens 7-2a has not reached the driving end position (NO in S404), the autofocus detection processor 108-3 goes back to the process in S401.

When the position of the focus lens 7-2a has reached the end position (YES in S404), the autofocus detection processor 108-3 executes the focused state detection process by using the calculated AF evaluation value (S405), and completes the AF process.

Next, the focused state detection process will be described. The focused state detection process is a process which detects a pattern of AF evaluation values for each AF area, and specifies the focused position by detecting the focused position. The pattern of AF evaluation values includes three patterns.

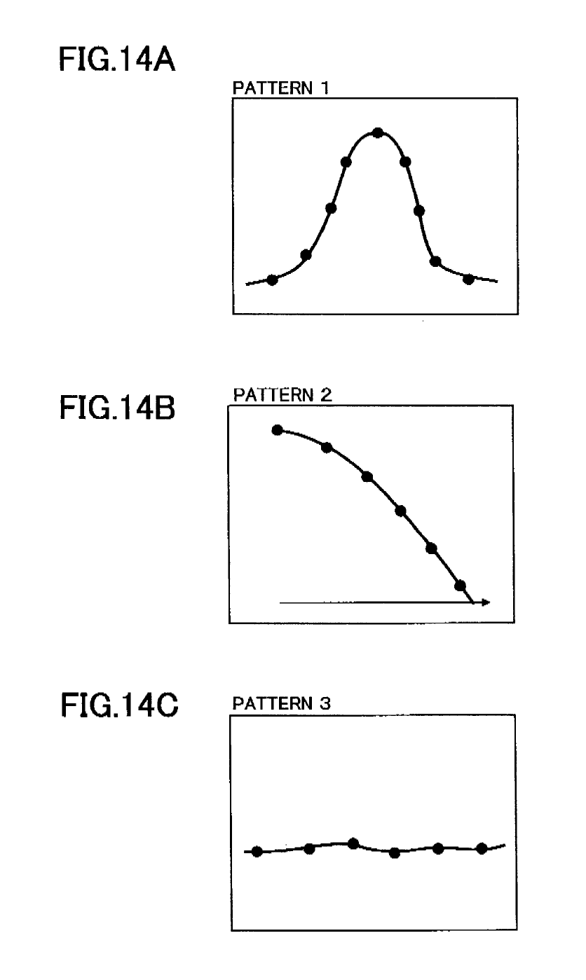

FIGS. 14A-14C are schematic views each illustrating one example of the evaluation value pattern in the AF area determination process. FIG. 14A illustrates a pattern 1 which can specify the focused position by detecting a hill of evaluation values. FIG. 14B illustrates a pattern 2 in which the evaluation values monotonically decreases after the peak in the focused position because a distance between a subject and an imaging device is shorter than the minimum shooting distance. FIG. 14C illustrates a pattern 3 which cannot detect a focused position because image data does not have contrast as determined from the evaluation values.

In the focused state detection process, the autofocus detection processor 108-3 determines any of the these three patterns, specifies a focused position in the case of pattern 1, executes close distance NG determination in the case of pattern 2, and determines impossibility for detecting a focused position in the case of pattern 3.

A method of detecting a focused position includes various methods such as a method of detecting a focused position from a differential value by smoothly differentiating evaluation values. Any of the methods can be used for the method of detecting a focused position.

The autofocus detection processor 108-3 executes an area determination process (S303) based on the result of the above AF process.

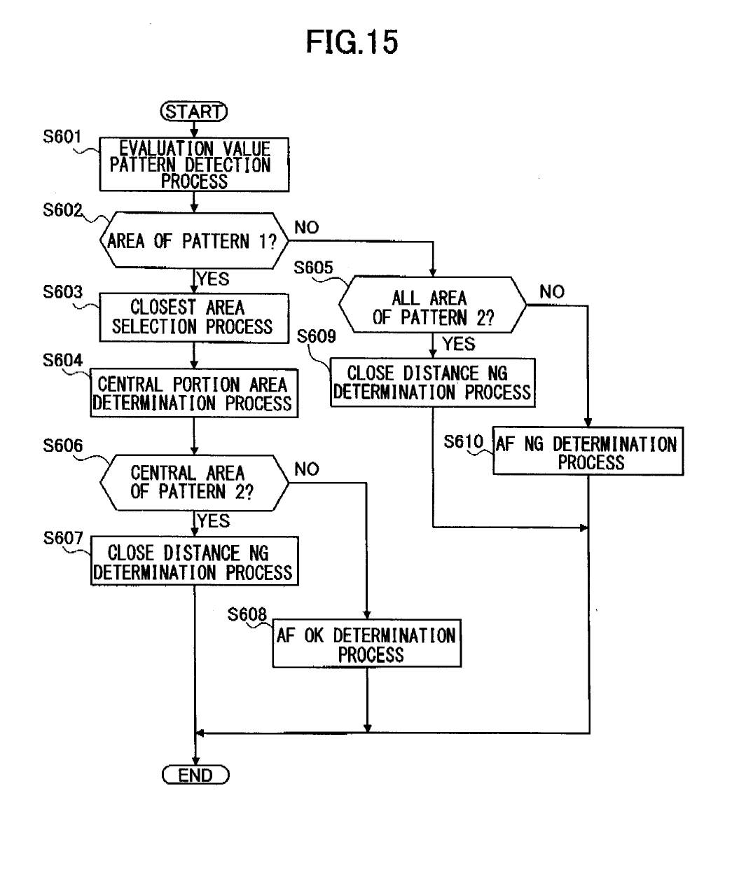

FIG. 15 is a flow chart describing the area determination process.

The autofocus detection processor 108-3 detects a pattern of AF evaluation values for each area in the multi-AF frame 41 in which the focused position is determined by the focused state detection process (S601).

The autofocus detection processor 108-3 which detects the pattern of AF evaluation values determines whether or not the detected evaluation values include the evaluation values of pattern 1 (S602).

When the area including the evaluation values of the pattern 1 is detected (YES in S602), the autofocus detection processor 108-3 selects as the closest area an area indicating the closest area in the areas (S603).

In addition, in the selection process of the closest area, the selected and determined algorithm can be changed as appropriate.

Next, the autofocus detection processor 108-3 determines the pattern of the AF evaluation values in the area (fifth area in multi-AF frame 41 in FIG. 9) of the central portion of the multi-AF frame 41 in the focused state detection process in the AF process (S604).

Regarding the process in S604, when the AF evaluation values in the central area of the multi-AF frame 41 are determined as the pattern 2, it can be estimated that a subject is stereoscopic subject having a projected central portion. In this case, a focal position may be located behind a subject.

In the present embodiment, a focal position behind a subject is detected in the process in S604. Namely, when the fifth area of the central area is the pattern 2 (YES in S606), the autofocus detection processor 108-3 determines a focal position behind a subject (close distance NG) because the area of the pattern 1 is located in an area except the central area (S607).

When the central area is determined as the pattern 1, the focus is detected in the central area, so that the autofocus detection processor 108-3 determines AF process OK (S608).

In the process in S602, when the areas of the multi-AF frame 41 do not have an area of the pattern 1 (NO in S602), it is determined whether or not all of the areas are the pattern 2 (S605).

In the process in S605, when all of the areas are the pattern 2 (YES in S605), the autofocus detection processor 108-3 determines the close distance NG (S609) similar to S607.

On the other hand, in the process in S605, when all of the areas are not the pattern 2 (NO in S605), the autofocus detection processor 108-3 determines that the focusing is impossible in all of the areas, and performs the determination of AF process NG (S610) because it is determined there is no area of the pattern 1 in the process in S602.

After the area determination process, the lens-moving processor 108-1 moves the position of the focus lens 7-2a based on the result of the area determination process.

Namely, as a result of the area determination process, when the focusing can be performed in the central area (AF process OK) (YES in S304), the lens-moving processor 108-1 moves the focus lens 7-2a in a focusable position (S305). After the movement of the focus lens 7-2a, the display mode-setting processor 108-2 displays a focus area on a subject in the focusable position (S307).

When the focusing cannot be performed in the central area (NO in S304), the lens-moving processor 108-1 determines whether or not it is determined as the close distance NG (S607, S609) in the area determination process (S306).

When it is determined as the close distance NG in the area determination process (YES in S306), the lens-moving processor 108-1 moves the focus lens 7-2a in the closest position (S308). After moving the focus lens 7-2a, the display mode-setting processor 108-2 changes the display mode to the edge extraction mode (S309). The edge detection processor 108-4 extracts the edge information from the image data and calculates the edge extraction mode screen 51 similar to S103 in Embodiment 1.

When the AF process NG is determined in the area determination process (S610), the lens-moving processor 108-1 moves the focus lens 7-2a in a hyperfocal position (S310). In this case, the display mode setting processor 108-2 can inform a user that the AF process is not performed by flashing and displaying the normal AF frame 40.

Moreover, the edge extraction mode screen 51 is displayed during a period in which the release switch SW1 is pressed, and returns to the normal mode screen 50 upon the releasing of the release switch SW1.

Operation and Effect of Embodiment 2

The imaging device 1 includes the focused state detector (autofocus detection processor 108-3) configured to detect a focused state for each of a plurality of areas in the image data based on the image data while moving the shooting lens, wherein the predetermined condition is satisfied when it is determined from the focused state detected by the focused state detector that a focused position is located in at least one area of the plurality of areas (YES in S602), and a distance between the subject and the shooting lens is shorter than a minimum shooting distance in a predetermined area of the plurality of areas (YES in S606).

Moreover, the predetermined condition is satisfied when it is determined from the focused state detected by the focused state detector that a distance between the subject and the shooting lens is shorter than a minimum shooting distance in all of the plurality of areas (S609).

According to the above imaging device 1, the autofocus detection processor 108-3 detects a focal point behind a subject in the position of the AF process, and the display mode setting processor 108-2 and the edge detection processor 108-4 changes the display mode to the edge extraction display mode, so as inform a user that the focal point is behind a subject.

Moreover, according to the imaging device, the focused position in the closest position can be visibly recognized, so that the focusing can be made near the central area of the multi-AF frame 41 by moving the imaging device after that.

According to the embodiment of the present disclosure the relationship between the minimum shooting distance of the imaging device and the subject distance can be easily determined, so that the usability can be improved.

### Embodiment 3

Next, Embodiment 3 as another example of the display process method will be described. In Embodiment 3, when a difference between a predetermined position on the close side and a lens position before moving is a predetermined value or more in the MF process mode similar to Embodiment 1, the focus lens 7-2a is moved by the AF process. When the difference is a predetermined value or below, the process similar to Embodiment 1 is performed.

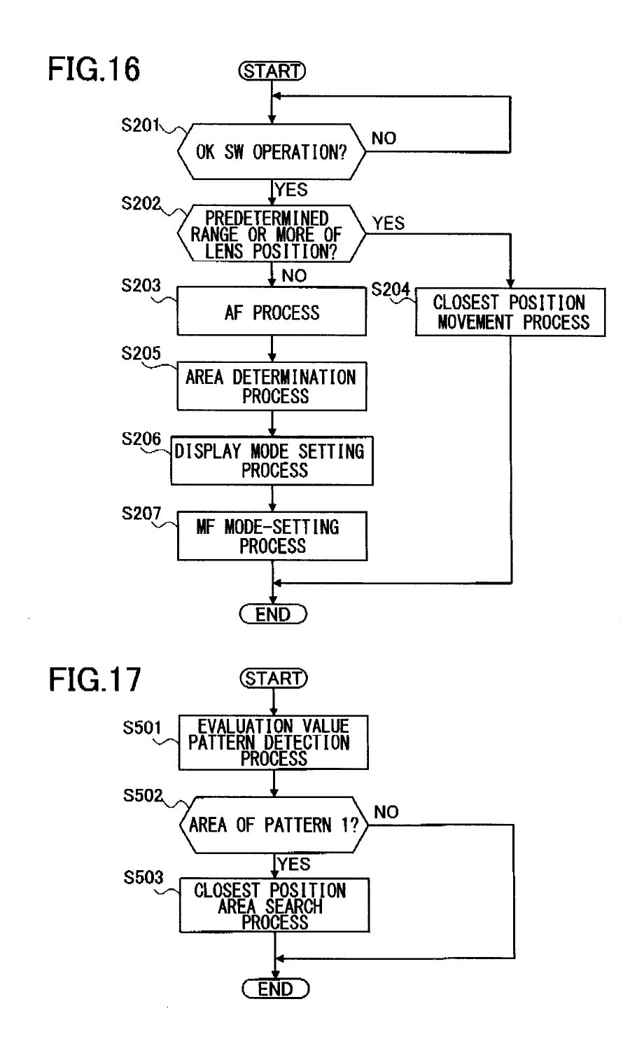

FIG. 16 is a flow chart describing the display process of Embodiment 3 by the imaging device 1.

In addition, in Embodiment 3, the default display in the finder mode is the normal mode screen 50.

The lens-moving processor 108-1 confirms whether or not the pressing of the OK switch SW12 which is a condition for moving the focus lens 7-2a is performed by a user (S201). The display process method (process after S202) of Embodiment 3 can be performed without the determination of the pressing of the OK switch SW13.

When the OK switch SW12 is pressed by a user (YES in S201), the lens-moving processor 108-1 determines whether or not the difference between the present position of the focus lens 7-2a and the predetermined position on the close side (closest position in this embodiment) is within a predetermined range or more (S202).

In the process in S202, the determination as to whether or not the difference is within a predetermined range or more is performed based on the AF evaluation value, for example, as a standard. When the determination is performed based on the AF evaluation value as a standard, it is necessary for the difference in the number of evaluation values between the AF evaluation value of the closest position and the AF evaluation value of the present position of the focus lens 7-2a to be at least 4 or more in order to determine the pattern when detecting the focused position.

Therefore, when determining whether or not the above difference is within a predetermined range or more, it is considered whether or not the difference in the number of evaluation values is 4 or more.

However, in the AF process, by setting the pulse rate of the focus motor 7-2b to be slower than the normal driving pulse rate, the difference in the number of evaluation values can be 4 or more, and thus, the difference in the number of evaluation values can be increased.

When the difference between the present position of the focus lens 7-2a and the closest position is not within a predetermined range (NO in S202), the autofocus detection processor 108-3 performs the AF process with the process start position as the present position of the focus lens 7-2a and the process end position as the closest position (S203). In this case, the AF process is a process similar to the flow chart of FIG. 13 as described in Embodiment 2. When the difference in the number of evaluation values is 4 or more, the AF process which moves the position of the focus lens 7-2a to the closest position is performed.

When the above difference is within a predetermined range (YES in S202), the focusing lens 7-2a cannot be moved by the AF process, so that the lens-moving processor 1084 moves the focus lens 7-2a to the closest position (S204) similar to S103 in Embodiment 1.

Next, the autofocus detection processor 108-3 performs the area determination process (S205) for performing the display mode-setting process based on the result of the AF process in S203.

FIG. 17 is a flow chart describing the area determination process in Embodiment 3 by the imaging device.

At first, the autofocus detection processor 108-3 performs a process which detects the evaluation value pattern (S501) relative to each area of the multi-AF frame 41 determined by the focused state detection process in S405 in the AF process.

After obtaining the evaluation value pattern, the autofocus detection processor 108-3 determines whether or not the area of the pattern 1 in which the focused position is detected is obtained.

When the area of the pattern 1 is obtained (YES in S502), the autofocus detection processor 108-3 searches an area in which the closest position is the focused position in the area of the pattern 1 (S503). In this case, when a plurality of areas where the closest position is the focused position is obtained, the autofocus detection processor 108-3 records everything.

When the area of the pattern 1 is not obtained (NO in S502), the autofocus detection processor 108-3 completes the area determination process.

After the area determination process in S205, the display mode-setting processor 108-2 changes the display mode to the edge extraction mode (S206). The display mode setting processor 108-2 displays the focused area on the LCD monitor 10 when the focused area of the pattern 1 detected by the area determination process is obtained.

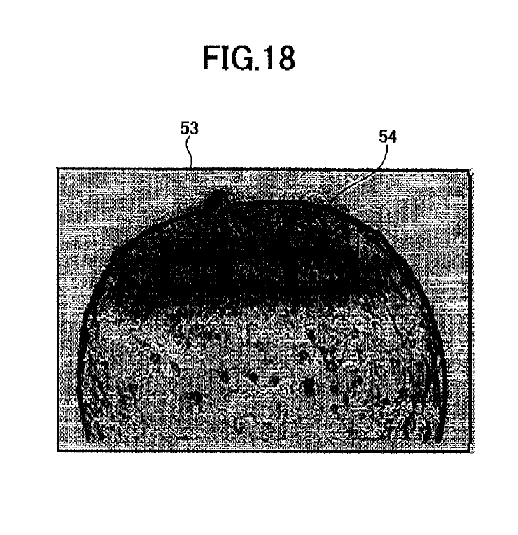

FIG. 18 is a schematic view illustrating the display example of the edge extraction mode screen 53 of Embodiment 3. A focused area display (focus detection area) 54 of the pattern 1 is displayed by a rectangular frame. In this way, according to the imaging device 1, the position focused in the closest position is displayed, so that a user can easily and visibly recognize the position of the imaging device 1 and a subject.

After displaying the focused area display 54 on the edge extraction mode screen 53, the imaging device 1 changes the focus detection mode to MF (S207) such that the AF process is not performed even when the release switch SW1 is pressed. Therefore, a user can moves the position of the imaging device 1 to the subject with reference to the focused area display 54, and quickly start shooting.

The display of the edge extraction mode screen 51 on the LCD monitor 10 can be released when the OK switch SW12 is again pressed, for example, and the display is switched to the normal mode screen 50.

The difference between Embodiments 2, 3 is that the edge extraction mode display is performed when the distance to a subject is short when performing the normal AF process in Embodiment 2, whereas when the difference between the closest position and the present position of the lens is not within the predetermined range, the AF process and the area determination process are performed, and the edge extraction mode display is performed by displaying the determined area in Embodiment 3.

Operation and Effect of Embodiment 3

In Embodiment 3, the predetermined condition is satisfied when a difference between a lens position before moving, which is a position before moving the shooting lens to the predetermined position on the close side, and the predetermined position on the close side is a predetermined value or more. According to the imaging device 1, when the above difference is a predetermined value or more, the lens is moved to the predetermined position on the close side, and the focus information can be displayed on the display. Therefore, in the case of shooting at the periphery of the predetermined position on the close side of the shooting lens, when adjusting the position of the shooting lens and the imaging device 1, a user can easily focus on a subject, so that the time to start shooting can be reduced.

The imaging device 1 includes the focused state detector which detects a focus state for each of a plurality of areas in the image data based on the image data while moving the shooting lens to a predetermined position from a lens position before moving. When a focused position is located in at least one area of a plurality of areas, and the focus detection area where the focused position corresponds to the closest position of the shooting lens is located in a plurality of areas, the focus detection area is displayed in the display section.

According to the imaging device 1, when the shooting lens is moved to the closest position from the lens position before moving, the focus detection area of a subject has been already detected. Accordingly, according to the imaging device 1, the changing degree of the focusing by the MF operation or the moving degree of the imaging device 1 can be easily recognized, so that the usability can be improved.

According to the embodiments of the present disclosure, a user can easily recognize the positional relationship between the imaging device and the subject.

Although the embodiments of the present disclosure have been described above, the present disclosure is not limited thereto. It should be appreciated that variations may be made in the embodiments described by persons skilled in the art without departing from the scope of the present disclosure.

What is claimed is:

1. An imaging device, comprising:
a shooting lens configured to image an image of a subject through passage of light from the subject;
an imaging unit configured to receive light which has passed through the shooting lens, and convert the received light into an electric signal, so as to generate image data of the subject; and
a display on which the image data is displayed, wherein
when a predetermined condition is satisfied, the shooting lens is moved to a predetermined position on a close side, focal point information is calculated from the image data, and the image data is displayed on the display by a display mode which visibly displays the focal point information.

2. The imaging device according to claim 1, wherein the predetermined condition is satisfied when an operation unit of the imaging device is operated.

3. The imaging device according to claim 1, wherein
the focal point information is edge information, and
the display mode is a mode which visibly displays the edge information of the image data.

4. The imaging device according to claim 1, comprising a focused state detector configured to detect a focused state for each of a plurality of areas in the image data based on the image data while moving the shooting lens, wherein
the predetermined condition is satisfied when it is determined from the focused state detected by the focused state detector that a focused position is located in at least one area of the plurality of areas, and a distance between the subject and the shooting lens is shorter than a minimum shooting distance in a predetermined area of the plurality of areas.

5. The imaging device according to claim 1, comprising a focused state detector configured to detect a focused state for each of a plurality of areas in the image data based on the image data while moving the shooting lens, wherein
the predetermined condition is satisfied when it is determined from the focused state detected by the focused state detector that a distance between the subject and the shooting lens is shorter than a minimum shooting distance in all of the plurality of areas.

6. The imaging device according to claim 1, wherein the predetermined condition is satisfied when a difference between a lens position before moving, which is a position before moving the shooting lens to the predetermined position on the close side, and the predetermined position on the close side is a predetermined value or more.

7. The imaging device according to claim 6, comprising a focused state detector configured to detect a focused state for each of a plurality of areas in the image data based on the image data while moving the shooting lens from the lens position before moving to the predetermined position, wherein
when it is determined from the focused state detected by the focused state detector that a focused position is located in at least one area of the plurality of areas, and a focus detection area where the focused position corresponds to a closest position of the shooting lens is located in the plurality of areas, the focus detection area is displayed on the display.

8. The imaging device according to claim 1, wherein the predetermined position of the shooting lens on the close side is a closest position.

9. A display process method which is performed by an imaging device including a shooting lens configured to image an image of a subject through passage of light from the subject, an imaging unit configured to receive light which has passed through the shooting lens, and convert the received light into an electric signal, so as to generate image data of the subject, and a display on which the image data is displayed,
the method comprising the step of moving the shooting lens to a predetermined position on a close side, calculating focal point information from the image data, and displaying the image data on the display by a display mode which visibly displays the focal point information when a predetermined condition is satisfied.
